(19) United States
(12) Patent Application Publication
(10) Pub. No.: US 2002/0000148 A1
(43) Pub. Date: Jan. 3, 2002

(54) Device for trimming wane-affected planks

(76) Inventor: Georges L. Brun, Saint Didier Au Mont D' Or (FR)

Correspondence Address: OLIFF & BERRIDGE, PLC, P.O. BOX 19928, ALEXANDRIA, VA, 22320, US

(21) Appl. No.: 09/824,806

(22) Filed: Apr. 4, 2001

(30) Foreign Application Priority Data
Apr. 14, 2000 (FR) 00.04878

(51) Int. Cl. B26D 7/00

(52) U.S. Cl. 83/520

(57) ABSTRACT

Device for trimming wane-affected planks The device makes it possible to optimize the work of a trimming machine with multiple blades. It comprises, in the plank transfer assembly located upstream of the trimming machine, between the scanner and the trimming-machine entry table, an intermediate preparation table (10) facing which are arranged means of emitting at least two light beams, particularly four laser beams (L1, L2, L3, L4) directed onto a plank (24) stopped on the preparation table (10) and forming marks on this plank. The position of the beams can be modified manually and remotely by an operator to take account of wane zones (25, 26) and defects (27, 28) in the heart of the wood. This corrected position is taken into consideration automatically by the positioning of the blades of the trimming machine accordingly.

The present invention relates to machines for sawing wood that are used in saw mills. It relates more specifically to a device for trimming wane-affected planks which makes it possible to optimize the work of a trimming machine with multiple blades.

It is recalled that wooden planks for squaring, originating from the sawing of logs, initially have rough-cut edges which exhibit irregularities known as “wanes”, which make the regions of these edges unusable over some width or another. In addition, such planks often have defects of appearance in their central region (the region known as the “heart”).

The conventional system for trimming is as follows: the planks arrive transversely and are positioned by an operator in a position which is correct in terms of length, with the wane visible on the topside. Each plank then passes under a scanner, which is an opto-electrical device that makes it possible to measure the edge of the plank. Next, this plank is introduced, directly after it exits the scanner, into a trimming machine with multiple blades which, in general, is a machine employing circular saw blades which can be shifted transversely, a computer associated with the scanner having already positioned the blades in the position that will allow the supposed optimum recovery of pieces of wood which have been squared on four sides.

In this conventional design, no visual check on the computer's decision, with the possibility of correcting this decision and therefore of “repositioning” the blades is made. In addition, defects frequently present in the heart of the wood are not taken into consideration, and this leads to a fairly high end-product scrap rate.

The present invention aims to avoid these drawbacks by supplying a device which allows a check and possibly a correction to be made and which is capable of taking defects in the heart of the wood into consideration.

For this purpose, the device for trimming wane-affected planks that is the subject of the invention comprises, in its plank-transfer assembly located upstream of the trimming machine with multiple blades fand used to feed the latter, more particularly between the scanner and the trimming-machine entry table, an intermediate preparation table facing which are arranged means of emitting at least two light beams directed onto the location of a plank stopped on this preparation table, manually remotely controllable means being provided for modifying the position of these light beams, and other means being provided for automatically taking the corrected positions of the light beams into consideration by positioning the blades of the trimming machine accordingly.

As a preference, the means of emitting at least two light beams consist of at least two laser beam emitters which project at least two laser marks onto a wane-affected plank stopped at the aforementioned location.

Thus, the invention proposes stopping each plank in an intermediate position as it exits the scanner, in which position it is trued and in which two or more lines of light, for example four laser marks, initially positioned by the computer of the plant, allow a suitably positioned operator to view exactly the cutting layout devised by this computer, on the basis of measurements provided by the scanner and the programming of the computer. If the operator deems that, as the result of a defect in structure or appearance of the plank or an error in assessing the geometry of this plank by the computer, he needs to correct the positions of the cutting lines, he will have the option of repositioning the laser marks, and the computer will reconsider the laser marks' corrected-position information to then reposition the blades of the trimming machine according to the operator's wishes, when that very plank is introduced into the trimming machine. In particular, with the use of four laser beams, the interactive device that is the subject of the invention makes it possible to optimize the operation of a trimming machine by taking into account, in the most precise way possible, not only the wane zones kept outside the two outermost laser marks, but also defects in the heart, which are isolated between the two innermost laser marks.

In any event the invention will be better understood with the aid of a description which follows, with reference to the appended schematic diagram which, by way of example, depicts one embodiment of this device for trimming wane-affected planks:

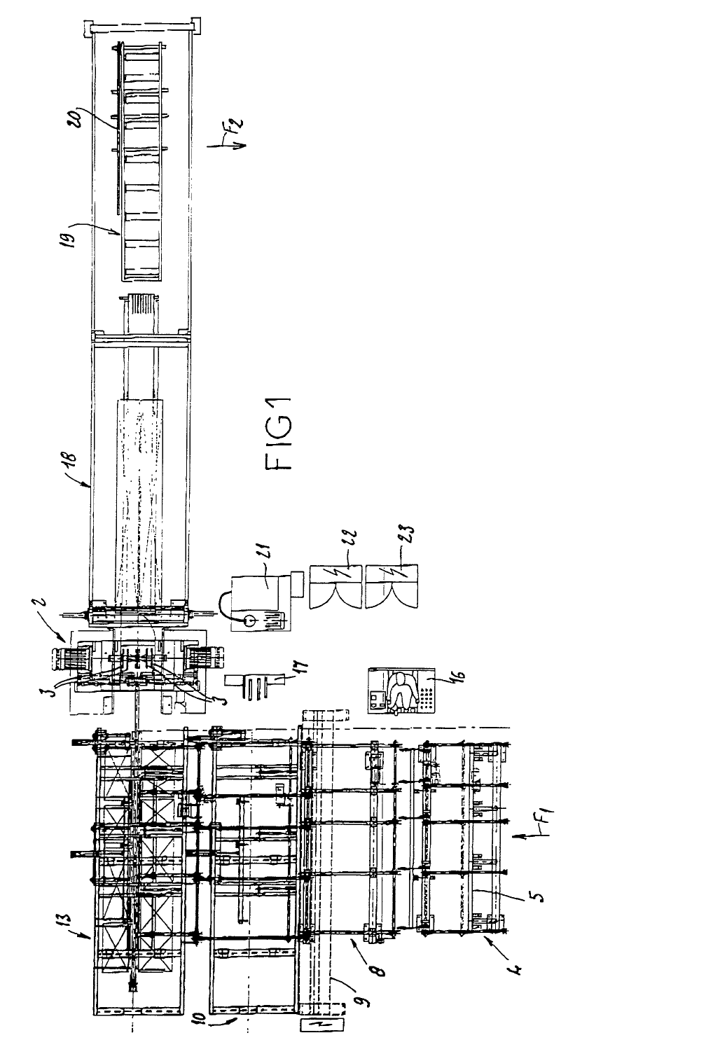

FIG. 1 is an overall plan view from above of a sawing plant equipped with the device that is the subject of the invention;

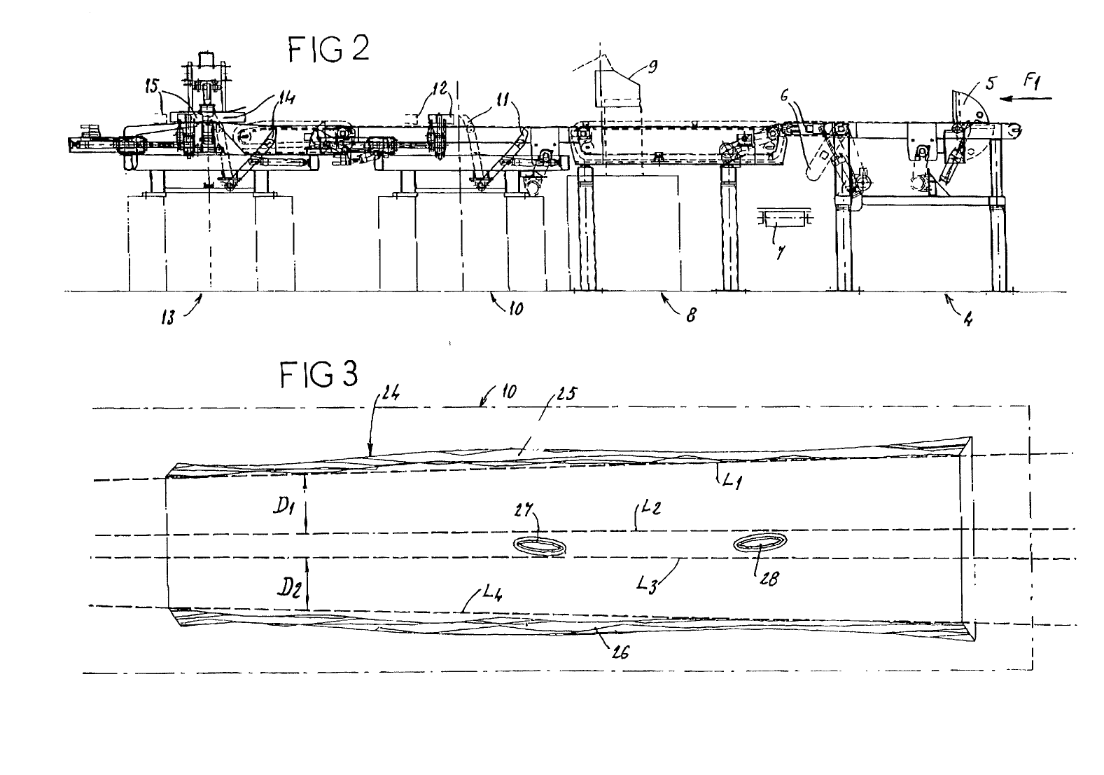

FIG. 2 is a side view of the installation of FIG. 1;

FIG. 3 is a diagram depicting a wane-affected plank and the position of the laser marks on this plank.

FIG. 1 depicts, in its entirety, an installation comprising a trimming machine 2 with four circular blades 3 which are parallel and moveable transversely. The invention is concerned more specifically with the equipment provided on the plank inlet side, this plank arrival occurring in the direction of an arrow F1, this equipment also being shown in a side view in FIG. 2.

From the upstream to the downstream direction, this equipment comprises, in succession:

a feed transfer element 4, with plank turners 5 and a bypass 6 for removing waste onto a conveyor 7;

a passage transfer element 8, over which a scanner 9 is arranged;

a preparation table 10, with a pushing arm 11 and aligning guides 12;

an entry table 13 with pusher arm 14 and aligning guides 15, located directly facing the trimming machine 2.

Facing the aforementioned elements is a control station 16 where an operator is situated. Facing the preparation table 10 is also an emitter assembly 17 which simultaneously emits four laser beams toward this preparation table 10.

Downstream of the trimming machine 2, in line with the latter, there is an edge-trimmings separator 18, with a protective tunnel, which is followed by a set of rollers 19 with ejectors 20 and a protective tunnel, so that the end products can exit laterally in the direction of an arrow F2.

The installation also comprises a hydraulic unit 21 and electrical cabinets 22 and 23.

In operation, the rough-cut planks which still have wanes on, arriving in the direction of the arrow F1, are transferred and possibly turned over by the feed transfer element 4, then are transferred further on by the passage transfer element 9, thus passing under the scanner 9 which precisely measures the contours of these planks, particularly the profile of their longitudinal edges. The planks thus arrive, in succession, on the preparation table 10 where they are stopped and positioned by the pushing arm 11 and by the aligning guides 12 which allow each plank to be “trued”.

For each plank thus stopped in an intermediate position on the preparation table 10, and as also shown in FIG. 3, the emitting assembly 17 projects simultaneously onto the plank 24 four laser marks L1, L2, L3 and L4 oriented more or less in the longitudinal direction of this plank 24, the initial positions of the laser marks being determined by the measurement of the plank 24 performed using the scanner 9, and by the programming of the installation computer.

The operator, situated at the control station 16, then makes a visual check and, using appropriate remote controls provided at this work station and acting on the emitter assembly 17, can shift the four laser marks L1, L2, L3 and L4. This repositioning of the four laser marks L1, L2, L3 and L4 is performed, by the operator, in such a way as to take account of the wane zones 25 and 26 of the plank 24, and of defects such as those indicated as 27 and 28, which are fairly often encountered in the region of the heart of the wood. The two outermost laser marks L1 and L4 are positioned respectively at the boundary of the two wane zones 25 and 26, and the two innermost laser marks L2 and L3 are positioned as close as possible to the defects 27 and 28, on each side of these defects. This positioning defines the optimized maximum widths D1 and D2 of the end products that can be obtained from the rough-cut plank 24.

Once this operation has been performed, the plank is directed toward the entry table 13, where it is positioned by the pushing arm 14 and by the aligning guides 15, then this plank is introduced through the trimming machine 2.

The four moving blades 3 of the trimming machine 2 are automatically positioned according to the choice made by the operator using the laser marks L1, L2, L3 and L4 and they therefore saw the wane-affected plank in the optimized way. The squared products thus obtained reach the trimmings separator 18 where they are separated from one another, and finally reach the set of rollers 19 where the ejectors 20 cause them to exit in the direction of the arrow F2.

As goes without saying, the invention is not restricted to the single embodiment of this device for trimming wane-affected planks has that been described hereinabove by way of example; on the contrary, it encompasses all alternative embodiments and applications thereof that follow the same principle. In particular, it would not be departing from the scope of the invention if the number of blades in the trimming machine were to be increased or reduced, with a corresponding reduction or increase in the number of laser marks projected onto the planks, for example by providing a trimming machine with six moving blades, and a set of six laser marks at the preparation table, or by applying the same device to a trimming machine that uses blades of a type other than circular blades.

1. Device for trimming wane-affected planks, making it possible to optimize the work of a trimming machine (2) with multiple blades (3), characterized in that it comprises, in its plank-transfer assembly located upstream of the trimming machine (2) and used to feed the latter, more particularly between a scanner (9) and a trimming-machine entry table (13), an intermediate preparation table (10) facing which are arranged means (17) of emitting at least two light beams (L1, L2, L3, L4) directed onto the location of a plank (24) stopped on this preparation table (10), manually remotely controllable means being provided for modifying the position of the light beams (L1, L2, L3, L4), and other means being provided for automatically taking the corrected positions of the light beams (L1, L2, L3, L4) into consideration by positioning the blades (3) of the trimming machine (2) accordingly.

2. Device for trimming wane-affected planks according to claim 1, characterized in that the means (17) of emitting at least two light beams consist of at least two laser beam emitters which project at least two laser marks (L1, L2, L3, L4) onto a wane-affected plank (24) stopped at the aforementioned location.

3. Device for trimming wane-affected planks according to claim 2, characterized in that four laser marks (L1, L2, L3, L4) are projected onto the wane-affected plank (24), the two outermost laser marks (L1, L4) being positioned with respect to the boundary of the wane zones (25, 26) of the plank (24), and the two innermost laser marks (L2, L3) being positioned as close as possible to the defects (27, 28) in the heart of the wood, on each side of these defects.
